(19) United States
(12) Patent Application Publication
(10) Pub. No.: US 2007/0008273 A1
(43) Pub. Date: Jan. 11, 2007

(54) Source driver for liquid crystal display

(75) Inventors: Yi-chan Chen, Madou Township (TW); Wei-Chung Cheng, Ninosong Township (TW); San-Yueh Huang, Sigang Township (TW)

Correspondence Address: TROXELL LAW OFFICE PLLC;SUITE 1404, 5205 LEESBURG PIKE., FALLS CHURCH, VA, 22041, US

(73) Assignee: Elan Microelectronics Corp.

(21) Appl. No.: 11/358,211

(22) Filed: Feb. 22, 2006

(30) Foreign Application Priority Data
Jul. 8, 2005 (TW) 094123247

(51) Int. Cl. G09G 3/36

(52) U.S. Cl. 345/100

(57) ABSTRACT

The present invention provides a source driver used in an LCD, especially a big LCD, so that energy consumed can be saved together with small amplitude and reduced electromagnetic interference.

### FIELD OF THE INVENTION

The present invention relates to a source driver; more particularly, relates to using an LCD (liquid crystal display) with saved energy, small amplitude and low EMI (electromagnetic interference).

### DESCRIPTION OF THE RELATED ART

A general source driver for TFT-LCD (Thin-Film-Transistor LCD) comprises parts with high voltage and parts with low voltage, having the following charateristics:

(A) The power consumption by parts with high voltage mainly comes from operational amplifiers; and the power consumption depends on panel load. It is possible for the parts with high voltage to save energy only if the panel is driven by a small static current to run the operational amplifiers.

(B) The power consumption for parts with low voltage mainly come s from the following two sources:

(1) A dynamic current of a logic circuit: The dynamic current of the logic circuit depands on a VDD volume and an operational frequency.

(2) A static current of an RSDS (Reduced Swing Differential Signal) transmission interface: The RSDS transmission interface requires ten high-speed comparators, which contribute most of the energy consumption of the parts with low voltage.

The way a conventional RSDS transmission interface saves energy depends on a basic operational rule for a source driver in an LCD panel. Please refer to FIG. 3, which is a block view showing a basic operational flow of an LCD of a prior art. Take an XGA (eXtended Graphics Array, 1204×768) panel for example. An initial-signal terminal 30 and eight 384-channel source drivers 31˜31g are required, where initial-pulse output terminals 33˜33g of the source drivers 31˜31g are connected with initial-pulse input terminals 32˜32g of the source drivers 31˜31g. The data of a whole line to be displayed is serially passed to the first source driver 31 until the last source driver 31g one by one. When the system is going to transfer the data of the line, a pulse will be sent to the initial-pulse input terminal 32 of the first source driver 31 to inform of the starting of data transference. When the data transference required for the first source driver 31 is finished, the initial-pulse output terminal 33 will transfer a pulse to the initial-pulse input terminal 32a of the second source driver 31a to inform of the starting of data transference. When the data transference required for the second source driver 31a is finished, the initial-pulse output terminal 33a will transfer a pulse to the initial-pulse input terminal 32b of the third source driver 31b to inform the start of data transference. In the same way, data is transferred to the following source drivers 31c˜31g until all of the eight source drivers 31˜31g fetch the data required. And, then, the system will uniformly send a pulse to all source drivers 31˜31g so that all source drivers 31˜31g will transform fetched data into corresponding voltages to drive panel for displaying the data of the line. And remaining lines is displayed in the same way.

Please further refer to FIG. 4, which is a block view showing a source driver of the prior art. For a common 6-bit source driver in an RSDS-transmitting LCD, the RSDS transmission interface requires ten high-speed comparators 4˜4i, where one comparator 4 is used for processing timing signals and the other nine comparators 4a˜4i are used for processing data signals. However, the operational frequency for the RSDS transmission interface is quite high (645 MHz-100 MHz) so that the static power consumption for the comparators 4˜4i is quite high. For further saving power consumption, two directions of solution are considered: one is to reduce the static power consumption for each comparator 4˜4i to a level as low as possible; and the other one is to save non-critical power consumption at the system end.

The second solution is usually taken as a conventional way to save power consumption. Please refer to FIG. 5, which is a block view showing a transferring method of the prior art. As referring to the basic operational rule for an LCD panel, any source driver 31˜31g uses its RSDS transmission interface only when receiving data signals 53˜53g. So, a conventional way for saving energy is done by pausing comparators 4a˜4i (shown in FIG. 4) which are not transferring data signals to stop consuming power; but timing signals continues running regardless of the pausing. Hence, during the time for displaying data of a line, any source driver 31˜31g saves ⅞ of the original power consumption. Yet, the conventional way for saving energy enables all comparators 4a˜4i of the source drivers 31˜31g during the time for displaying the data of the line because timing signals 52˜52g are still required for any source driver 31˜31g to detect sudden initial pulses from the initial-signal terminal 51 no matter the transference of the RSDS data is finished or not. Besides, the timing signals 52˜52g processed by comparator in the RSDS transmission interface is the foundation for logic, so that the comparators 4˜4i which process timing signals 52˜52g of the source drivers 31˜31g are never paused during the time of displaying the data of the line. Furthermore, because the operational frequency for the RSDS transmission interface is quite high (65 MHz-100 MHz), it is quite hard to reduce the power cons u med by the comparators 4˜4i So, the prior art does not fulfill users' requests on actual use.

### SUMMARY OF THE INVENTION

Therefore, the main purpose of the present invention is to use an LCD, especially a big LCD, with saved energy, small amplitude and low EMI.

To achieve the above purpose, the present invention is a source driver for an LCD, used in an RSDS interface, comprising an initial-signal terminal and a plurality of source drivers, where each source driver is connected to the initial-signal terminal an initial-pulse output terminal of each source driver is connected to the initial-pulse input terminal of the next source driver; timing signals and data signals are transferred to the first source driver until the last source driver one by one; after a data signal transference to a source driver is finished, the timing signal transference is disabled; then, the initial-pulse output terminal of the source driver outputs a wake-up signal; and, then, the next source driver is actuated earlier than a default time by using the wake-up signal. Accordingly, a novel source driver for an LCD is obtained.

### BRIEF DESCRIPTION OF THE DRAWINGS

The present invention will be better understood from the following detailed description of the preferred embodiment according to the present invention, taken in con junction with the accompanying drawings, in which

FIG. 1 is a block view showing a basic operational flow according to a preferred embodiment of the present invention;

FIG. 2 is a block view showing a transferring method according to the preferred embodiment of the present invention;

FIG. 3 is a block view showing a basic operational flow of a liquid crystal display ( LCD) of a prior art;

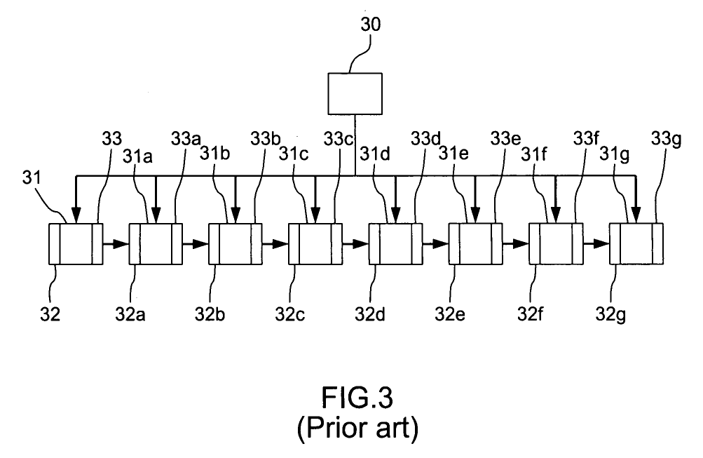

FIG. 4 is a block view showing a source driver of the prior art; and

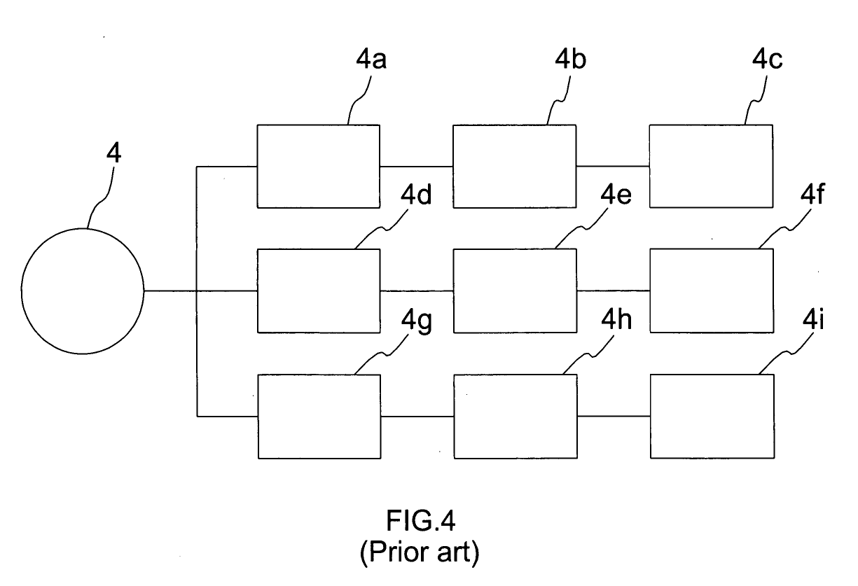

FIG. 5 is a block view showing a transferring method of the prior art.

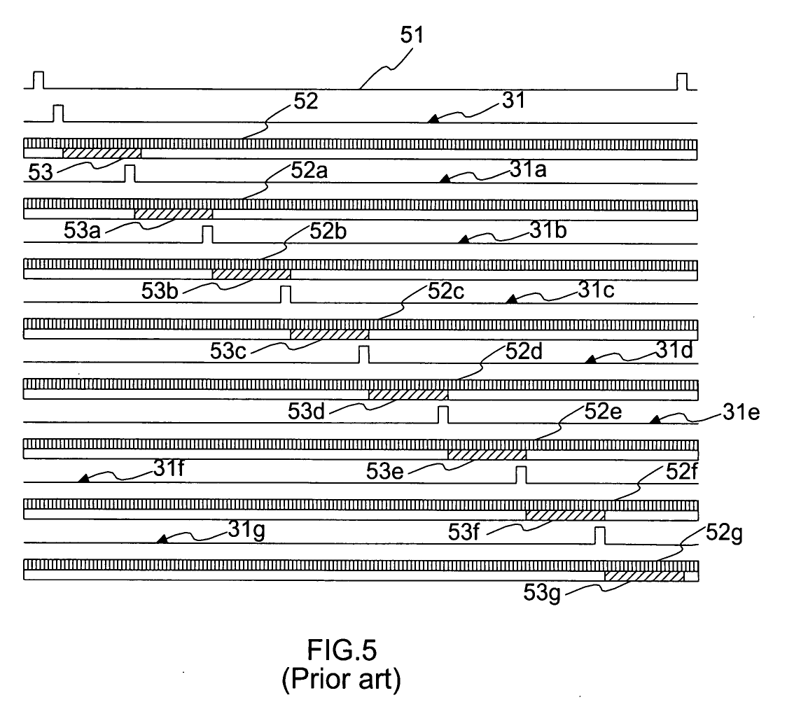

### DESCRIPTION OF THE PREFERRED EMBODIMENT

The following description of the preferred embodiment is provided to understand the features and the structures of the present invention.

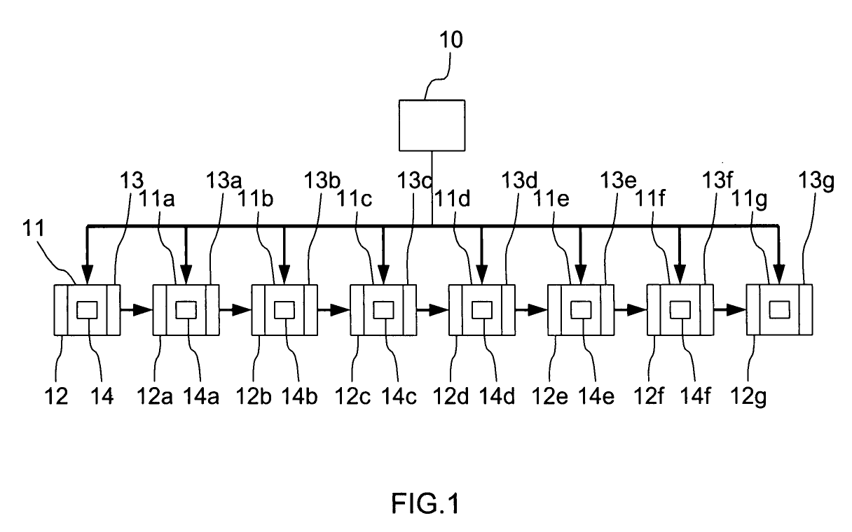

Please refer to FIG. 1, which is a block view showing a basic operational flow according to a preferred embodiment of the present invention. As shown in the figure, the present invention is a source driver for an LCD used in an RSDS (Reduced Swing Differential Signal) interface, comprising an initial-signal terminal 10 and a plurality of source drivers 11˜11g. Therein, each source driver 11˜11g is connected to the initial-signal terminal 10, and comprises an initial-pulse input terminal 12 and an initial-pulse output terminal 13. The source drivers 11˜11g are connected to each other in a serial way where the initial-pulse output terminal 13˜13f of each source driver 11˜11f is connected to the initial-pulse input terminal 12a˜12g of the next source driver 11a˜11g to form a sequence, except the last source driver 11g in the sequence. Timing signals and data signals are transferred to the first source driver 11 until the last source driver 11g one by one. Therein, the timing signals transference for a source driver 11˜11g is stopped when the data signals transference for the source driver 11˜11g is finished. After the data signals transference is finished, the initial-pulse output terminal 13˜13f of the source driver 11˜11f outputs a wake-up signal 14˜14f before a default time to wake next source driver 11a˜11g _k up for restarting transferring timing signals. As a result, a novel source driver for an LCD is obtained.

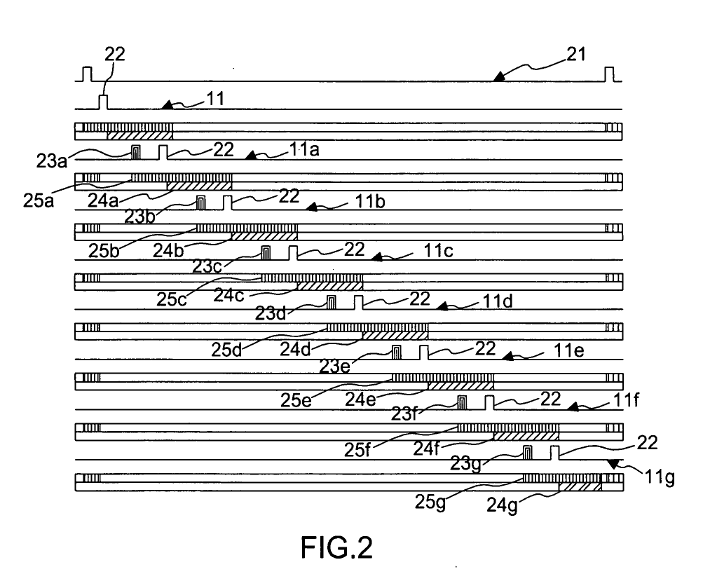

Please refer to FIG. 2, which is a block view showing a transferring method according to the preferred embodiment of the present invention. As shown in the figure, the way for saving energy in the present invention comprises the following steps:

(a) After a source driver 11˜11f receives RSDS data signals 24 24f, the timing signals 25˜25f for the timing-signal comparator of the source driver 11˜11f is disabled.

(b) Then, an initial-pulse output terminal 13˜13f (shown in FIG. 1) of the source driver 11˜11f (except the last source driver 11g) outputs a wake-up signal 23˜23f.

(c) And, the next source driver 11a˜11g is actuated earlier than a default time by using the wake-up signal 23˜23f so that the comparator to be used in the next source driver 11a˜11g obtains ample time to enter into a state for a general operation of receiving RSDS data signals 24a˜24g.

Because the initial pulse 22 is sent defaultly by the system it self to the initial-pulse input terminal 12 (shown in FIG. 1) of the first source driver 11 to actuate the first source driver 11 while every other source drivers 11a˜11g is actuated ahead of time by a wake-up signal 23˜23f, an initial-signal terminal 21 and the initial-pulse input terminal 12 are required to identify the first source driver 11 among the source drivers 11˜11g so that the comparator in the first source driver 11 is not in short of time to enter into a state for a general operation, or the first source driver 11 fetches wrong RSDS data signals owing to wrong timing for the initial-pulse input terminal 12 of the first source driver 11.

After the initial-signal terminal 21 of the panel is setup explicitly, the initial pulse 22 for the first source driver 11 is sent periodically. So, once the initial-signal terminal 21 is actuated, all source drivers 11˜11g must enable their own timing-signal comparators. If the initial-pulse input terminal 12˜12g of a source driver 11˜11g receives another initial pulse 22 during a default period of time after the initial-signal terminal 21 is actuated, the source driver 11˜11g which receives initial pulse 22 again is recognized as the first source driver 11 of the system. Then, the timing of the first source driver 11 is adjusted to be different from those timings of the other source drivers 11a˜11g so that correct data is fetched. Regarding the other source drivers 11a˜11g, if initial pulse 22 is not received after the source driver 11a˜11g is actuated, the source driver 11a˜11g is determined as none the first source driver 11, while the timing-signal comparator of the source driver 11a˜11g is stopped at first and is not enabled until receiving another initial pulse 22. By doing so, the timing-signal comparator saves energy to a degree of a little higher than ⅛ of the original energy consumed, which consumes almost just as much energy as data-signal comparator does.

In addition, the wake-up signal 23˜23f is obtained from a circuit of a plurality of transistors. The transistor can be connected with at least one component in a serial or a parallel way for a matching. The component is a resistance, a diode, a capacitance or another transistor. And, the transistors comprises a basic structure of a BJT Bipolar Junction Transistor) transistor a FET (Field-Effect Transistor) transistor, a MOS (Metal-Oxide Semiconductor) transistor or a CMOS Complementary Metal-Oxide Semiconductor) transistor.

To sum up, the present invention is a source driver for an LCD, used with saved energy, small amplitude and low electromagnetic interference.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A source driver for a liquid crystal display (LCD), comprising:
(a) an initial-signal terminal; and
(b) a plurality of source drivers,
wherein said source driver is connected to said initial-signal terminal;
wherein said source drivers are connected with each other to obtain a sequence of said source drivers;
wherein said source driver comprises an initial-pulse input terminal and an initial-pulse output terminal;
wherein said initial-pulse output terminal of said source driver, except last source driver in said sequence, is connected to said initial-pulse input terminal of next source driver in said sequence;
wherein timing signals and data signals are transferred to first source driver in said sequence to last source driver in said sequence; and
wherein said timing signals for a source driver is stopped transferring when a transferring of said data signals for said source driver is finished; after said transferring of said data signals is finished, said initial-pulse output terminal of said source driver outputs a wake-up signal before a default time to wake next source driver in said sequence up for restarting transferring timing signals.

2. The source driver according to claim 1, wherein said initial-signal terminal is defaultly setup to periodically transfer an initial pulse to said initial-pulse input terminal of said first source driver in said sequence to start said first source driver.

3. The source driver according to claim 1, wherein said wake-up signal is obtained from a circuit of a plurality of transistors.

4. The source driver according to claim 3, wherein said transistor is connected in a parallel way to at least one component selected from a group consisting of a resistance, a diode, a capacitance and another transistor.

5. The source driver according to claim 3, wherein said transistor is connected in a serial way to at least one component selected from a group consisting of a resistance, a diode, a capacitance and another transistor.

6. The source driver according to claim 1, wherein said plurality of transistors comprises a basic structure of a BJT (Bipolar Junction Transistor) transistor

7. The source driver according to claim 3, wherein said plurality of transistors comprises a basic structure of a FET (Field-Effect Transistor) transistor.

8. The source driver according to claim 3, wherein said plurality of transistors comprises a basic structure of a MOS (Metal-Oxide Semiconductor) transistor.

9. The source driver according to claim 3, wherein said plurality of transistors comprises a basic structure of a CMOS (Complementary Metal-Oxide Semiconductor) transistor.
